(19) United States
(12) Patent Application Publication
(10) Pub. No.: US 2009/0135611 A1
(43) Pub. Date: May 28, 2009

(54) MULTI-FUNCTIONAL LANTERN

(75) Inventor: Jui-Li LIN, Taichung Hsien (TW)

Correspondence Address: PATENTTM.US, P. O. BOX 82788, PORTLAND, OR, 97282-0788, US

(73) Assignee: QUASAR OPTOELECTRONICS, INC., Taichung Hsien (TW)

(21) Appl. No.: 11/945,173

(22) Filed: Nov. 26, 2007

(51) Int. Cl. F21V 19/02

(52) U.S. Cl. 362/372

(57) ABSTRACT

A multi-functional lantern includes a body, at least one light bar and a flashlight assembly. The body has a base, a shell and a handle. The shell is formed on the base and has a distal end, an outer surface and at least one bar mount. The at least one bar mount is defined longitudinally in the outer surface of the shell and has a mounting end. The handle is mounted on the distal end of the shell. The at least one light bar is respectively mounted pivotally in a corresponding bar mount of the shell and is a planar lighting module having multiple diode components and a proximal end mounted pivotally in the mounting end of a corresponding bar mount. The flashlight assembly is mounted on the body.

### BACKGROUND OF THE INVENTION

1. Field of Invention

The present invention relates to a lantern, and more particularly to a multi-functional lantern.

2. Description of the Related Art

A conventional outdoor lantern is generally placed on a surface such as a table, ground or the like and beams light radially outward. The conventional outdoor lantern cannot shine light directly downwards, which is inconvenient for reading, playing cards, cooking and when watching and noting wildlife.

To overcome the shortcomings, the present invention provides a multi-functional lantern with flashlight and outdoor lamp functions to mitigate or obviate the aforementioned problems.

### SUMMARY OF THE INVENTION

The primary objective of the present invention is to provide a multi-functional lantern.

The multi-functional lantern in accordance with the present invention comprises a body, at least one light bar and a flashlight assembly. The body comprises a base, a shell and a handle. The shell is formed on the base and has a distal end, an outer surface and at least one bar mount. The at least one bar mount is defined longitudinally in the outer surface of the shell and has a mounting end. The handle is mounted on the distal end of the shell. The at least one light bar is respectively mounted pivotally in the at least one bar mount of the shell and is a planar lighting module having multiple diode components and a proximal end mounted pivotally in the mounting end of a corresponding bar mount. The flashlight assembly is mounted on the body. Therefore, the lantern can be used as an outdoor lantern with the at least one light bar disposed longitudinally, radially or obliquely relative to the body to shine light towards the base. The lantern can also be used as a flashlight with the flashlight assembly.

Other objectives, advantages and novel features of the invention will become more apparent from the following detailed description when taken in conjunction with the accompanying drawings.

### BRIEF DESCRIPTION OF THE DRAWINGS

FIG. 1 is an operational perspective view of a multi-functional lantern in accordance with the present invention, shown as a lantern;

FIG. 2 is a partially exploded perspective view of the multi-functional lantern in FIG. 1;

FIG. 3 is an enlarged side view in partial section of the lantern in FIG. 1;

FIG. 4 is another enlarged side view in partial section of a distal end of the lantern in FIG. 1;

FIG. 5 is an operational perspective view of the lantern in FIG. 1, shown down-casting light; and

FIG. 6 is another operational perspective view of the lantern in FIG. 1, shown as a flashlight.

### DETAILED DESCRIPTION OF THE INVENTION

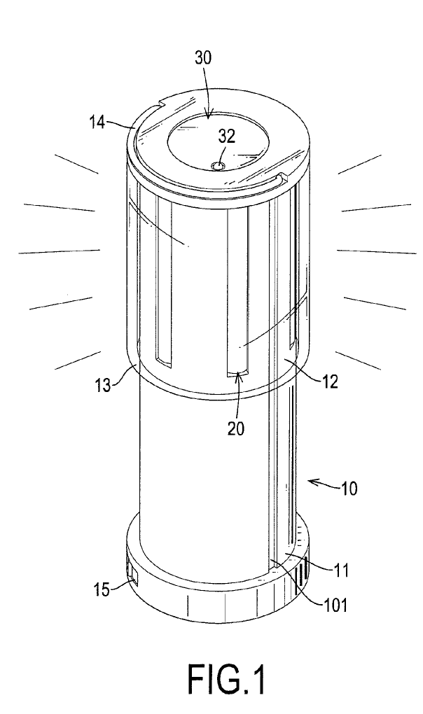

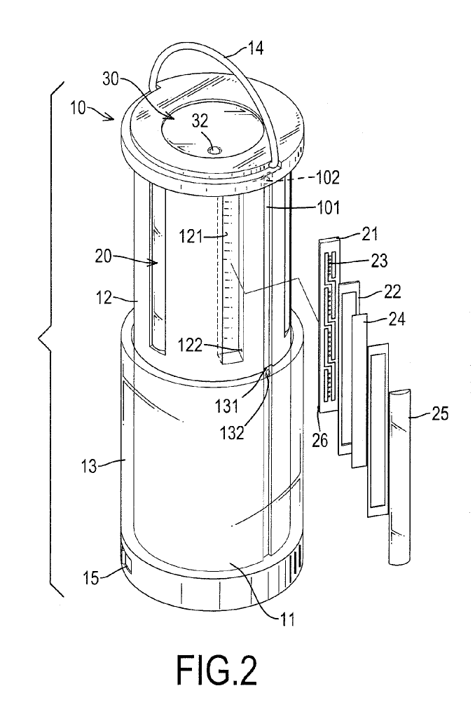

With reference to FIGS. 1 and 2, a multi-functional lantern with flashlight and outdoor lamp functions in accordance with the present invention comprises a body (10), at least one light bar (20) and a flashlight assembly (30).

The body (10) may be cylindrical and has an outer surface, a base (11), a shell (12), an optional diffusion cover (13), a handle (14), an optional switch (15) and at least one optional guide (101) having an optional positioning boss (102).

The base (11) may comprises a power supply and corresponding electronic components including but not limited to a battery pack, rechargeable power supply with charging terminal, low voltage DC input and the like.

The shell (12) is formed on and protrudes from the base (11) and has a distal end, an outer surface and at least one bar mount (121). The at least one bar mount (121) is defined longitudinally in the outer surface of the shell (12) and has a mounting end Preferably six bar mounts (121) are implemented. The bar mounts (121) are disposed at equal intervals around the outer surface of the shell (12), are substantially quadrangular and each bar mount (121) has two longitudinal surfaces and two pivoting holes (122). The pivoting holes (122) are defined respectively in the longitudinal surfaces near the mounting end of the bar mount (121).

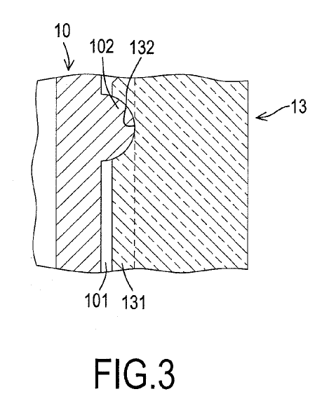

With further reference to FIG. 3, the diffusion cover (13) is mounted slidably around the body (10), is held in place by at least one boss and detent, may be cylindrical, transparent or translucent, selectively covers the bar mounts (121) and has a flashlight end, an inner surface, at least one optional guiding protrusion (131) having an optional detent (132). The guiding protrusion (131) is formed on and protrudes from the inner surface of the diffusion cover (13). The detent (132) is formed on and protrudes from the guiding protrusion (131) near the upper end of the diffusion cover (13).

The handle (14) is mounted on the distal end of the shell (12) for carrying or hanging the lantern.

The switch (15) is mounted on the base (11) to turn the lantern on or off and may be button switch, slide switch and the like or may be integrated between the base (11) and shell (12).

The guide (101) is defined longitudinally in the outer surface of the body (10), corresponds to and engages with the guiding protrusion (131) of the diffusion cover (13).

The positioning boss (102) is formed on the guide (101), corresponds to and selectively engages the detent (132) of the diffusion cover (13).

The at least one light bar (20) is respectively mounted pivotally in the at least one bar mount (121) of the shell (12) and is a planar lighting module having multiple diode components and a proximal end mounted pivotally in the mounting end of a corresponding bar mount (121), may be using the pivot holes (122) and may comprise at least one detent to selectively hold the light bar (20) longitudinally, radially or obliquely relative to the body (10). Preferably six light bars (20) are implemented.

Each one of the at least one light bar (20) may comprise a board (21), a frame (22), multiple diodes (23), a luminescent sheet (24) and a lens (25). The board (21) may have a rear cover, corresponds to and is mounted pivotally in a corresponding bar mount (121) and has a proximal end, an outer surface, at least one edge and a pivot (26). The pivot (26) is formed on the proximal end of the board (21) and is mounted in the pivoting holes (122) of a corresponding bar mount (121). The frame (22) is attached to the outer surface of the board (21) along the edge of the board (21). The diodes (23) are mounted on the outer surface of the PCB (21) inside the frame (22) and may emit ultraviolet (UV) or near UV light. The luminescent sheet (24) is attached to the frame (22) and covers the diodes (23) to change wavelengths of light emitted from the diodes (23). The lens (25) is mounted on the frame (22), is light-transmitting and convex.

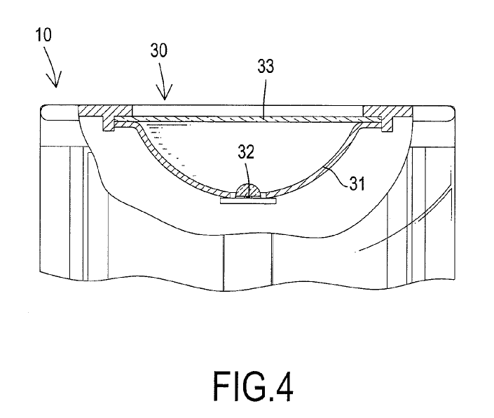

With further reference to FIG. 4, the flashlight assembly (30) is mounted on the body (10), may be on the distal end of the shell (12) or in the base (11) and may comprise a reflector (31), at least one light emitting diode (32) (LED) and a light cover (33). The reflector (31) is mounted centrally on the body (10) and has a center and a rim. The light emitting diode (32) is mounted in the center of the reflector (31). The light cover (33) is mounted on the rim of the reflector (31) and covers the light emitting diode (32).

When the diffusion cover (13) is positioned around the shell (12) and held covering the at least one light bar (20) by the detent (132), light shines radially out from the lantern for general use.

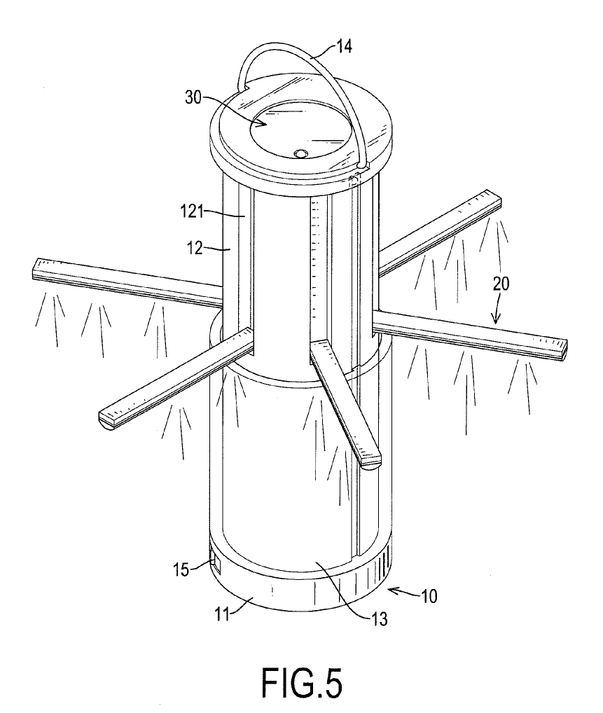

With further reference to FIG. 5, when the diffusion cover (13) is not implemented or slid to open the at least one light bar (20), the at least one light bar (20) may be pivoted relative to and protrude radially from the body (10), to shine light directly toward the base (11) or substantially toward the base (11). Therefore, the multi-functional lantern may be used for reading, drawing, cooking, especially cutting beneath the lantern and in an oblique configuration may be used for playing cards, eating or the like. Additionally, the at least one light bar (20) can held in position at different angles using the diffusion cover (13) and multiple detents (132) formed thereon.

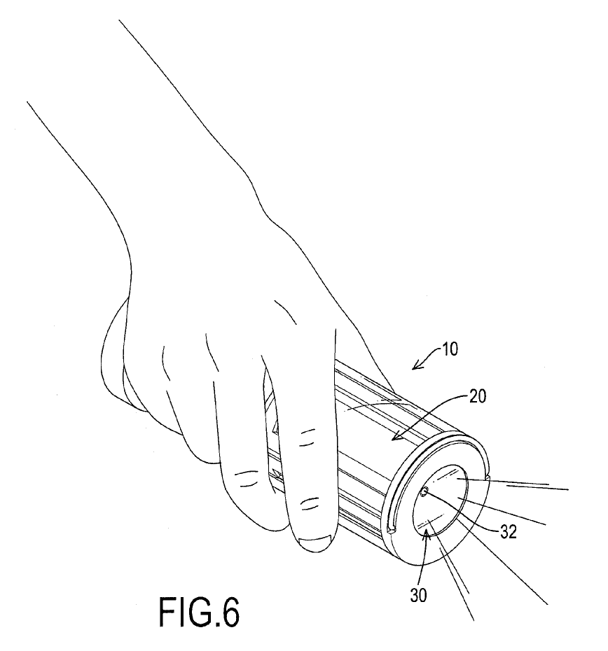

With reference to FIG. 6, the multi-functional lantern can also be used as a flashlight by sliding the diffusing cover (13) over each light bar (20) and activating the flashlight assembly (30). Therefore the multi-functional lantern has multiple interchangeable functions for use outdoors.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A multi-functional lantern comprising
a body having
an outer surface;
a base;
a shell being formed on and protruding from the base and having
a distal end;
an outer surface; and
at least one bar mount being defined longitudinally in the outer surface of the shell and having a mounting end; and
a handle being mounted on the distal end of the shell;
at least one light bar being respectively mounted pivotally in the at least one bar mount of the shell, and each one of the at least one light bar being a planar lighting module and having
multiple diode components; and
a proximal end being mounted pivotally in the mounting end of a corresponding bar mount; and
a flashlight assembly being mounted on the body.

2. The lantern as claimed in claim 1, wherein the body further has a diffusion cover mounted slidably around the body selectively covering the at least one bar mount and held in place by at least one detent and boss.

3. The lantern as claimed in claim 2, wherein
the diffusion cover has
an inner surface; and
at least one guiding protrusion being formed on and protruding out from the inner surface; and
the body further has at least one guide being defined longitudinally in the outer surface of the body, corresponding respectively to and engaging the at least one guiding protrusion of the diffusion cover.

4. The lantern as claimed in claim 3, wherein each one of the at least one light bar comprises
a board corresponding to and being mounted pivotally in a corresponding bar mount and having an outer surface and at least one edge;
a frame being attached to the outer surface of the board along the edge of the board;
multiple diodes being mounted on the outer surface of the board inside the frame; and
a lens being mounted above the frame and being light-transmitting.

5. The lantern as claimed in claim 4, wherein each one of the at least one light bar further comprises a luminescent sheet attached to the frame and covering the diodes on the light bar.

6. The lantern as claimed in claim 5, wherein
the shell has six bar mounts being disposed at equal intervals around the outer surface of the shell; and
the lantern comprises six light bars.

7. The lantern as claimed in claim 6, wherein
each bar mount has
two longitudinal surfaces; and
two pivoting holes being defined respectively in the longitudinal surfaces near the mounting end of the bar mount; and
the board of each light bar has
a proximal end; and
a pivot being formed on the proximal end of the board and mounted in the pivoting holes of a corresponding bar mount.

8. The lantern as claimed in claim 1, wherein
the shell has multiple bar mounts being disposed at equal intervals around the outer surface of the shell; and
the lantern comprises multiple light bars.

9. The lantern as claimed in claim 8, wherein
each bar mount has
two longitudinal surfaces; and
two pivoting holes being defined respectively in the longitudinal surfaces near the mounting end of the bar mount; and
the board of each light bar has
a proximal end; and
at least one pivot being formed on the proximal end of the board and mounted in the pivoting holes of a corresponding bar mount.
